(19) United States
(12) Patent Application Publication
(10) Pub. No.: US 2020/0407274 A1
(43) Pub. Date: Dec. 31, 2020

(54) TEXTURED GLASS SURFACES FOR REDUCED ELECTROSTATIC CHARGING

(71) Applicant: CORNING INCORPORATED, CORNING, NY (US)

(72) Inventors: Gabriel Pierce AGNELLO, Corning, NY (US); He JING, Corning, NY (US); Christine Coulter WOLCOTT, Horseheads, NY (US)

(21) Appl. No.: 16/977,176

(22) PCT Filed: Mar. 5, 2019
(86) PCT No.: PCT/US2019/020802

§ 371 Date: Sep. 1, 2020

Related U.S. Application Data
(60) Provisional application No. 62/639,702, filed on Mar. 7, 2018.

(51) Int. Cl. C03C 21/00; B32B 17/06; C03C 15/00

(52) U.S. Cl. CPC C03C 21/002; C03C 2204/08; C03C 15/00; B32B 17/06

(57) ABSTRACT

A substrate with a textured surface is disclosed. The textured glass substrate exhibits low haze and a significant reduction in contact electrostatic charging when compared to an un-textured but otherwise identical glass substrate. Methods of producing the textured surface by an in situ mask etching process are also disclosed.

### CROSS-REFERENCE TO RELATED APPLICATIONS

This application claims the benefit of priority to U.S. Provisional Application Ser. No. 62/639,702 filed on Mar. 7, 2018 the contents of which are relied upon and incorporated herein by reference in their entirety as if fully set forth below.

### BACKGROUND

### Field

The present invention relates generally to textured surfaces for display applications, and more particularly to textured surfaces of glass substrates to mitigate electrostatic effects.

### Technical Background

Contact electrostatic charging is a challenge for flat panel display manufacture due to the creation of high surface potential differences that can lead to a number of issues, including field induced electrostatic discharge failure of electronic components, particle-based contamination stemming from electrostatic attraction, and electrostatic stiction-induced glass breakage during packaging and processing. Several types of surface treatments have been successfully utilized to reduce contact charging phenomena, with two of the most common being the application of one or more thin film coatings and texturing and/or chemical modification of the glass surface(s). Roughening surfaces by way of simple etching has historically improved contact charging between two large flat surfaces through the reduction of electrostatic forces by limiting total contact area. However, some methods, for example those employing acetic acid, and more particularly acetic acid solutions with low water content, can be dangerous to use, as acetic acid in concentrated form is damaging to tissue and can be highly flammable.

### SUMMARY

In accordance with one or more embodiments disclosed herein, a “maskless” etching technique may be used to texture glass substrates. The method involves a low cost, wet chemical etching process for texturing a glass substrate to suppress electrostatic charging of such glass substrates during processing.

Creating texture on glass surfaces using fluoride-containing solutions requires an etch mask, since without a mask amorphous homogenous silicate glass tends to etch evenly on a scale larger than the molecular level, reducing a thickness of the glass substrate, but without creating texture. Many methods have been proposed for masking glass etching to provide patterned textures for various applications. Such methods can be divided into those requiring a separate masking process prior to etching and those that form a mask in situ during etching, so-called “maskless” etching since there is no mask prior to the start of the etching. For the purposes of this disclosure, a mask can be considered as any material that provides a barrier to etching, and may be applied to a glass surface with various lateral sizes and with various levels of durability and adhesion to the glass.

Many methods of mask application, such as ink jet printing, do not enable the creation of small nanometer-scale features on the glass surface. In fact, most methods produce textures on a micrometer scale in both lateral feature size and depth of etch and so create a visible “frosted” appearance to glass that reduces transparency, increases haze, and decreases glare and surface reflectivity.

In situ masking and glass etching involves a complex process of mask formation from byproducts of glass dissolution plus etchant. Precipitates that form (sometimes crystalline) are often somewhat soluble in the etchant, making modeling of this process difficult. Moreover, creating a differential etch using maskless etching may involve multiple steps to create the mask by contact with a frosting solution or gel, and subsequent steps to remove the mask and etchant. In situ etch masks can also produce various textures depending on their adhesion to the substrate and durability in the wet etchant, and it can be shown that less durable masks result in shallower textures. Depth of etch is also determined by the size of the mask regions, with smaller mask regions unable to support deeper etch profiles because mask undercutting occurs more readily. Therefore, mask chemistry, glass chemistry, etch chemistry and glass composition should all be considered when forming nanometer-scale textures.

Accordingly, a glass substrate comprising a chemically treated major surface is disclosed, the glass substrate comprising a haze value equal to or less than about 1% and, when compared to an untreated otherwise identical glass substrate, further comprises an improvement in electrostatic charging (ESC) performance of greater than 70% when subjected to a Lift Test performed on the chemically treated major surface.

The glass substrate may further comprise an improvement in transmittance of at least about 0.25% over a wavelength range from 350 nm to 400 nm when compared to the untreated otherwise identical glass substrate.

In some embodiments, the glass substrate can be a chemically strengthened glass substrate.

In some embodiments, the glass substrate is a laminated glass substrate comprising a first glass layer including a first coefficient of thermal expansion and a second glass layer fused to the first glass layer and comprising a second coefficient of thermal expansion different from the first coefficient of thermal expansion.

The chemically treated major surface comprises a plurality of raised features, and an average feature density of the raised features on the treated major surface is in a range from about 0.2 to about 1 features/μm². An average feature volume of the raised features may be in a range from about 0.014 to about 0.25 μm³. A total surface area of the raised features relative to the total surface area of the chemically treated major surface may be in a range from about 4% to about 35%.

In some embodiments, an average surface roughness Ra of the chemically treated major surface can be in a range from about 0.4 nanometers to about 10 nanometers.

In another embodiments, a method of forming a textured glass substrate is disclosed comprising treating a major surface of the glass substrate with an etchant comprising acetic acid in an amount from about 50 wt % to about 60 wt %, ammonium fluoride in an amount from about 10 wt % to about 25 wt %, and water in an amount from about 20 wt % to about 35 wt %.

In some embodiments, a total haze value of the glass substrate after the treating the glass substrate is less than 1% and, when compared to an untreated but otherwise identical glass substrate, the glass substrate exhibits an increase in ESC performance greater than 70%.

In some embodiments, the surface of the glass substrate is exposed to the etchant for a time less than about 30 seconds, for example at a temperature in a range from about 18° C. to about 60° C. during the exposure.

An average surface roughness Ra of the treated major surface can be in a range from about 0.4 nanometers to about 10 nanometers.

Additional aspects and advantages of the embodiments described herein will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments of the present disclosure, and are intended to provide an overview or framework for understanding the nature and character of the embodiments as they are claimed. The accompanying drawings are included to provide a further understanding of the embodiments, and are incorporated into and constitute a part of this specification. The drawings illustrate various embodiments of the present disclosure and together with the description serve to explain the principles and operations of the embodiments.

### BRIEF DESCRIPTION OF THE DRAWINGS

FIG. 1 is a cross sectional edge view of a glass substrate comprising a protective film applied to a surface thereof;

FIG. 2 is a graph of relative electrostatic charging for four sample etching solutions as a function of time, expressed as a percent improvement over an otherwise identical un-etched sample;

FIG. 3 is a graph showing optical transmission of four etched samples S1-S4, and an un-etched sample S0, expressed as a percent as a function of wavelength, over a wavelength range from 350 nm to 800 nm;

FIG. 4 is a graph showing optical transmission of the four etched samples S1-S4, and the un-etched sample S0 of FIG. 3, expressed as a percent as a function of wavelength, over a wavelength range from 350 nm to 400 nm;

FIG. 5 is a graph showing optical transmission change of the four etched samples S1-S4 of FIG. 4 expressed as a percent as a function of wavelength, over the wavelength range from 350 nm to 400 nm;

FIG. 6 is a ternary plot of a compositional space of suitable etchants that maintain a percent haze less than 1%;

FIG. 7 is a scanning electron microscope image of a glass substrate sample depicting multiple etch-formed “features” with a generally smooth topography;

FIG. 8 is a scanning electron microscope image of another glass substrate sample depicting multiple etch-formed “features” with a high peak density;

FIG. 9 is a schematic diagram illustrating the general concept of features and peaks;

FIG. 10 is a plot illustrating ESC performance as a function of feature density;

FIG. 11 is a plot illustrating ESC performance as a function of peak density; and

FIG. 12 is a plot depicting haze as a function of feature volume.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as may be used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “feature” unless otherwise indicated, refers to a nanometer-scale raised portion of a glass surface remaining after etching. A feature can be characterized by a three-dimensional topography including one or more peaks (high points) and valleys resulting from, e.g., undercutting of the deposited etch mask, and exhibit a top-down shape reminiscent of a snowflake or plant leaf.

Flat panel display glass used to build a display panel, and particularly that portion of the display panel including thin film transistors, consists of two sides, a functional side (“backplane”) upon which thin film transistors (TFTs) may be built (A-side) and a non-functional B-side. During processing, the B-side glass contacts a variety of materials (i.e. paper, metals, plastics, rubbers, ceramics, etc.) and can accumulate an electrostatic charge through triboelectrification. For example, when the glass substrate is introduced into the production line and an interleaving material is peeled from the glass substrate, the glass substrate can accumulate an electrostatic charge. Moreover, during the manufacturing process for semiconductor deposition, the glass substrate is commonly placed on a chucking table where the deposition is performed, with the B-side of the glass substrate in contact with the chucking table. The chucking table may, for example, restrain the glass substrate during processing via one or more vacuum ports in the chucking table. When the glass substrate is removed from the chucking table, the B-side of the glass substrate can be electrostatically charged through triboelectrification and/or contact electrification. Such electrostatic charge accumulation can cause many problems. For example, the glass substrate can be adhered to the chucking table by the electrostatic charge and the glass substrate subsequently broken when an attempt is made to remove the glass substrate from the chucking table. Moreover, due to the electrostatic charge, particles and dust can be attracted to the glass surface and contaminate it. More importantly, the release of electrostatic charge from the B-side to the A-side (electrostatic discharge, ESD) can cause failure of a TFT gate and/or line damage on the A-side that reduces product yield.

Methods described herein may be used to minutely texture a glass surface, thereby reducing the contact area in a manner that effectively reduces the intimacy of contact during triboelectrification and/or contact electrification and resulting in reduced glass voltage or surface charge without a noticeable reduction in the transparency of the glass, for example with minimal haze.

In accordance with one or more embodiments, a “maskless” etching technique is used to produce glass substrates that minimize electrostatic charging of glass substrates. Creating texture on glass surfaces using fluoride-containing solutions requires an etch mask, since without a mask amorphous homogenous silicate glass tends to etch evenly on a scale larger than the molecular level, reducing a thickness of the glass, but without creating texture. Many methods have been proposed for glass etching to provide patterned textures for various applications. Such methods can be divided into those requiring a separate masking process prior to etching and those that form a mask in situ during etching, so-called “maskless” etching (since there is no mask prior to the start of the etching). For the purposes of this disclosure, a mask can be considered any material that provides a barrier to etching, and may be applied to a glass surface with various levels of durability and adhesion to the glass.

Many methods of mask application, such as ink jet printing, have limitations on the scale of the mask that can be applied in that they do not enable the deposition of small, nanometer-sized masking regions. In fact, most methods produce glass textures that are on a micrometer scale in both lateral feature size and depth of etch and so create a visible “frosted” appearance to glass that reduces transparency, increases haze, and decreases glare and surface reflectivity.

In situ masking and glass etching involves a complex process of mask formation from byproducts of glass dissolution plus etchant. Precipitates that form are often somewhat soluble in the etchant, making modeling of this process difficult. Moreover, creating a differential etch using maskless etching may involve multiple steps to create the mask by contact with a frosting solution or gel, and subsequent steps to remove the mask and etchant. In situ etch masks can also produce various glass textures depending on their adhesion to the substrate and durability in the wet etchant, and it can be shown that less durable masks result in shallower textures. Depth of etch is also determined by the size of the masked regions, with smaller mask regions unable to support deeper etch profiles because mask undercutting occurs more readily.

In accordance with the present disclosure, an organic solvent is introduced to an inorganic acid to produce rapid localized precipitation that forms crystalline precipitates on a glass substrate surface. These precipitates are the etching byproducts, normally fluorosilicate salts, that mask the underlying glass surface and hinder etching in these locations. Residual crystalline precipitates can be dissolved away during a subsequent hot water wash or with an acid wash, leaving texture features on the glass surface resulting from the etching. By adjusting the organic solvent-to-etchant ratio, etch time, or etchant temperature a wide range of texture roughness can be obtained, from nanometer to micrometer range.

The chemical etch process includes etching the glass substrate in an aqueous etchant, for example an etchant bath, that comprises a mixture of an organic solvent (e.g., acetic acid, CH₃CO₂H) and an inorganic acid (e.g., ammonium fluoride, NH₄F), mixed in water. Without wishing to be held to a specific theory, it is believed the acetic acid reacts with the ammonium fluoride to form hydrofluoric acid and ammonium acetate. Silica from the glass surface is attacked by the HF and forms silicon tetrafluoride and water, and the silicon tetrafluoride combines with the surrounding HF and ammonium ions to form cryptohalite ((NH₄)₂SiF₆) on the glass surface, and hydrogen gas. When the etchant first contacts the glass surface, the glass begins to dissolve, and as the level of glass dissolution reactants reaches super saturation, crystals grow on the glass surface in two dimensions. As the etch reaction continues, a cobblestone-like passivation layer of cryptohalite is formed. When the etched glass substrate is removed from the etchant and rinsed, these crystals are dissolved, leaving behind hills and valleys that form a textured glass surface.

The glass substrate texture may be optimized by controlling parameters of the process, such as the composition of the etchant(s), the etching time, the etchant temperature and the glass temperature. A reliance on the addition of alkali or alkaline earth salts for removal of the mask may be unnecessary.

Other additives to the etchant may provide additional advantages. These additives may include: A dye to add color to the etchant and enable a visual aid for rinsing (common food-grade dye can suffice), and viscosity modifying components to thicken the etchant and enable painting (rolling) or spraying the etchant on the glass substrate rather than dipping. A thickened etchant can also reduce the vapor pressure of the etchant and thereby reduce defects caused by acid vapor contact with the substrate.

The glass substrate may comprise any suitable glass that can withstand the processing parameters expressly or inherently disclosed herein, for example an alkali silicate glass, an aluminosilicate glass, or an aluminoborosilicate glass. The glass material may be a silica-based glass, for example code 2318 glass, code 2319 glass, code 2320 glass, Eagle XG® glass, Lotus™, and soda-lime glass, etc., all available from Corning, Inc. Other display-type glasses may also benefit from the processes described herein. Thus, the glass substrate is not limited to the previously described Corning Incorporated glasses. For example, one selection factor for the glass may be whether a subsequent ion exchange process may be performed, in which case it is generally desirable that the glass be an alkali-containing glass.

Display glass substrates can have various compositions and be formed by different processes. Suitable forming processes include, but are not limited to float processes and down draw processes such as slot draw and fusion draw processes. See, for example, U.S. Pat. Nos. 3,338,696 and 3,682,609. The fusion manufacturing process offers advantages for the display industry, including glass substrates that are flat with excellent thickness control, with a pristine surface quality and scalability. Glass substrate flatness can be important in the production of panels for liquid crystal display (LCD) televisions as any deviations from flatness can result in visual distortions. Other processes that can be used in the methods disclosed herein are described in U.S. Pat. No. 4,102,664, U.S. Pat. No. 4,880,453, and U.S. Published Application No. 2005/0001201.

The glass substrates may be specifically designed for use in the manufacture of flat panel displays and can exhibit densities less than 2.45 g/cm³ and may, in some embodiments, exhibit a liquidus viscosity (defined as the viscosity of the glass at the liquidus temperature) greater than about 200,000 poise (P), or greater than about 400,000 P, or greater than about 600,000 P, or greater than about 800,000 P. Glass substrates used as display glass substrates can have a thickness in the range of 100 micrometers (μm) to about 0.7 μm, but other glass substrates that may benefit from the methods described herein may have a thickness in a range from about 10 μm to about 5 mm. Additionally, suitable glass substrates can exhibit substantially linear coefficients of thermal expansion over the temperature range of 0° to 300° C. of 28×10⁻⁷/° C. to about 57×10⁻⁷/° C., for example in a range from about 28×10⁻⁷/° C. to about 33×10⁻⁷/° C., or in a range from about 31×10⁻⁷/° C. to about 57×10⁻⁷/° C. In some embodiments, the glass substrate may include a strain point equal to or greater than about 650° C. The strain point of the disclosed compositions can be determined by one of ordinary skill in the art using known techniques. For example, the strain point can be determined using ASTM method C336.

Suitable glass substrates may have a Young's modulus equal to or greater than 10.0×10⁶ psi. Without being bound by any particular theory of operation, it is believed a high strain point may help prevent panel distortion due to compaction (shrinkage) during thermal processing subsequent to manufacturing of the glass. It is further believed a high Young's modulus may reduce the amount of sag exhibited by large glass substrates during shipping and handling.

As used herein, the term “substantially linear” means the linear regression of data points across the specified range has a coefficient of determination greater than or equal to about 0.9, or greater than or equal to about 0.95, or greater than or equal to about 0.98 or greater than or equal to about 0.99, or greater than or equal to about 0.995. Suitable glass substrates can include those glasses with a melting temperature less than about 1700° C.

Suitable glass substrates may exhibit a weight loss of less than 0.5 mg/cm² after immersion in a solution of 1 part HF and 10 parts NH₄F for 5 minutes at 30° C. In other embodiments the glass substrate can have a weight loss that is less than or equal to about 20 milligrams/cm² when a polished sample is exposed to a 5% HCl solution for 24 hours at 95° C., for example equal to or less than about 15 milligrams/cm², equal to or less than about 15 milligrams/cm², equal to or less than about 10 milligrams/cm², equal to or less than about 5 milligrams/cm², or equal to or less than about 1 milligrams/cm², such as equal to or less than about 0.8 milligrams/cm².

In embodiments of the described process, the glass substrate can comprise a composition in which the major components of the glass are SiO₂, Al₂O₃, B₂O₃, and at least two alkaline earth oxides. Suitable alkaline earth oxides include, but are not limited to MgO, BaO and CaO. The SiO₂serves as the basic glass former of the glass and has a concentration greater than or equal to about 64 mole percent to provide the glass with a density and chemical durability suitable for a flat panel display glass, e.g., a glass suitable for use in an active matrix liquid crystal display panel (AMLCD), and a liquidus temperature (liquidus viscosity) which allows the glass to be formed by a down draw process (e.g., a fusion process).

Suitable glass substrates can have an SiO₂ concentration less than or equal to about 71 mole percent to allow batch materials to be melted using conventional, high volume melting techniques, e.g., Joule melting in a refractory melter. In some embodiments, the SiO₂ concentration is in a range from about 66.0 mole percent to about 70.5 mole percent, or in a range from about 66.5 mole percent to about 70.0 mole percent, or in a range from about 67.0 mole percent to about 69.5 mole percent.

Aluminum oxide (Al₂O₃) is another glass former suitable for use with embodiments of the disclosure. Without being bound by any particular theory of operation, it is believed that an Al₂O₃ concentration equal to or greater than about 9.0 mole percent provides a glass with a low liquidus temperature and a corresponding high liquidus viscosity. The use of at least about 9.0 mole percent Al₂O₃ can also improve the strain point and the modulus of the glass. In detailed embodiments, the Al₂O₃ concentration may be in the range from about 9.5 to about 11.5 mole percent.

Boron oxide (B₂O₃) is both a glass former and a flux that aids melting and lowers the melting temperature. To achieve these effects, glass substrates suitable for use with embodiments of the present disclosure can have B₂O₃ concentrations equal to or greater than about 7.0 mole percent. Large amounts of B₂O₃, however, lead to reductions in strain point (approximately 10° C. for each mole percent increase in B₂O₃ above 7.0 mole percent), Young's modulus, and chemical durability.

In addition to the glass formers (SiO₂, Al₂O₃, B₂O₃), suitable glass substrates may also include at least two alkaline earth oxides, i.e., at least MgO and CaO, and, optionally, SrO and/or BaO. Without being bound by any particular theory of operation, it is believed that alkaline earth oxides provide the glass with various properties important to melting, fining, forming, and ultimate use. In some embodiments, the MgO concentration is greater than or equal to about 1.0 mole percent. In other embodiments, the MgO concentration may be in a range of about 1.6 mole percent and about 2.4 mole percent.

Without being bound by any particular theory of operation, it is believed that CaO produces low liquidus temperatures (high liquidus viscosities), high strain points and Young's moduli, and coefficients of thermal expansion (CTE's) in the most desired ranges for flat panel applications, specifically, AMLCD applications. It is also believed that CaO contributes favorably to chemical durability, and compared to other alkaline earth oxides, CaO is relatively inexpensive as a batch material. Accordingly, in some embodiments, the CaO concentration is greater than or equal to about 6.0 mole percent. In other embodiments, the CaO concentration in the display glass can be less than or equal to about 11.5 mole percent, or in the range of about 6.5 and about 10.5 mole percent.

In some embodiments, the glass substrate may comprise SiO2 in a range from about 60 mol % to about 70 mol %; Al₂O₃ in a range from about 6 mol % to about 14 mol %; B₂O₃ in a range from 0 mol % to about 15 mol %; Li2O in a range from 0 mol % to about 15 mol %; Na₂O in a range from 0 mol % to about 20 mol %; K₂O in a range from 0 mol % to about 10 mol %; MgO in a range from 0 mol % to about 8 mol %; CaO in a range from 0 mol % to about 10 mol %; ZrO₂ in a range from 0 mol % to about 5 mol %; SnO₂ in a range from 0 mol % to about 1 mol %; CeO₂ in a range from 0 mol % to about 1 mol %; less than 50 ppm As₂O₃; and less than 50 ppm Sb₂O₃; wherein 12 mol %≤Li₂O+Na₂O+K₂O≤20 mol % and 0 mol %≤MgO+CaO≤10 mol %, and wherein the silicate glass is substantially free of lithium.

In some embodiments, the glass substrate is nominally free from alkali metal oxides and has a composition, calculated in weight percent on the oxide basis, comprising about 49 to 67% SiO₂, at least about 6% Al₂O₃, SiO₂+Al₂O₃>68%, B₂O₃ in a range from about 0% to about 15%, at least one alkaline earth metal oxide selected from the group consisting of, in the preparations indicated, about 0 to 21% BaO, about 0 to 15% SrO, about 0 to 18% CaO, about 0 to 8% MgO and about 12 to 30% BaO+CaO+SrO+MgO.

Certain glass substrates described herein can be laminated glass. In some embodiments, the glass substrate is produced by fusion drawing a glass skin to at least one exposed surface of a glass core. Generally, the glass skin will possess a strain point equal to or greater than 650° C. In some embodiments, the skin glass composition has a strain point equal to or greater than 670° C., equal to or greater than 690° C., equal to or greater than 710° C., equal to or greater than 730° C., equal to or greater than 750° C., equal to or greater than 770° C., or equal to or greater than 790° C.

In some embodiments, the glass skin can be applied to an exposed surface of a glass core by a fusion process. An exemplary fusion process for forming laminated glass substrates can be summarized as follows. At least two glasses of different compositions (e.g., the base or core glass and the skin) are separately melted. Each of the glasses is then delivered through an appropriate delivery system to a respective overflow distributor. The distributors are mounted one above the other so that glass from each flows over top edge portions of the distributor and down at least one side to form a uniform flow layer of appropriate thickness on one or both sides of the distributor. The molten glass overflowing the lower distributor flows downwardly along the distributor walls and forms an initial glass flow layer adjacent to converging outer surfaces of the bottom distributer. Likewise, molten glass overflowing from the upper distributor flows downwardly over the upper distributor walls and flows over an outer surface of the initial glass flow layer. The two individual layers of glass from the two distributers are brought together and fused at a draw line formed where the converging surfaces of the lower distributor meet to form a single continuously laminated ribbon of glass. The central glass in a two-glass laminate is called the core glass, whereas the glass positioned on the external surface of the core glass is called the skin glass. A skin glass can be positioned on each surface of the core glass, or there may be only one skin glass layer positioned on a single side of the core glass.

It should be understood that the foregoing glass compositions are exemplary, and may other glass compositions may benefit from etching processes disclosed herein.

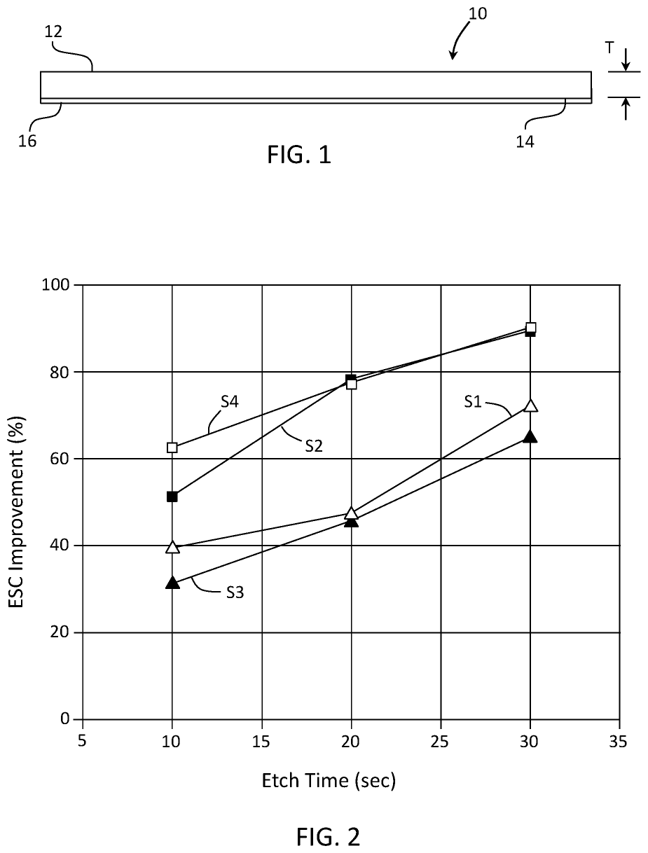

Shown in FIG. 1 is a glass substrate 10 comprising a first major surface 12, a second major surface 14, and a thickness T therebetween. The textured surface may be first major surface 12 or the textured surface may be second major surface 14. In some instances, both first and second surfaces 12, 14 may be textured. Textured surfaces produced according to methods of the present disclosure can provide a glass substrate that does not create a visibly frosted appearance to the glass. A frosted appearance reduces transparency of the glass substrate and increases haze.

In a first step of an exemplary etching process, the glass substrate to be etched is cleaned, for example using a detergent, to remove all inorganic contamination, then rinsed sufficiently to remove detergent residue. In one example, the glass substrate can be initially washed with a KOH solution to remove organic contaminants and dust on the surface as a pristine glass surface is needed to achieve uniformly distributed texture features on the glass surface. Other washing solutions may be substituted as needed. The presence of contaminants or dust on major surfaces of the glass substrate can act as nucleation seeds that can induce crystallization around them, resulting in a non-uniform glass surface texture. A level of cleanliness sufficient to obtain a water contact angle of less than about 20° C. should be attained. Contact angle can be evaluated using, for example, a DSA100 drop shape analyzer manufactured by Krüss GmbH and employing a sessile drop method, although other suitable methods may also be used. After cleaning, the glass substrate may optionally be rinsed, for example with deionized water.

In an optional second step of the process, if a surface of the glass substrate is not to be etched, e.g. second major surface 14, the surface not undergoing etching can be protected by applying an etchant-resistant protective film 16, for example a polymer film, to the surface. Etchant-resistant protective film 16 may be removed after the etching step(s).

In a third step, the glass substrate is contacted with an etchant for a time sufficient to create the desired texture. For immersion processes, fast insertion and suitable environmental controls, for example an ambient air flow of at least a 2.83 cubic meter per minute in the enclosure in which the etching occurs, may be used to limit exposure of the glass substrate to acid vapor prior to and/or during insertion. The glass substrate should be inserted into the etchant bath using a smooth motion to prevent defects forming in the etched surface of the glass substrate. The glass substrate should be dry prior to contact with the etchant. However, in some embodiments, other application methods may be used, for example painting (rolling) or spraying the etchant.

In embodiments, the etchant includes acetic acid (e.g., glacial acetic acid) in a concentration from about 50 percent by weight (wt %) to about 60 wt %, and ammonium fluoride in a concentration in a range from about 10 wt % to about 25 wt %. The etchant further includes water in an amount in a range from about 20 wt % to about 35 wt %, for example in a range from about 20 wt % to about 30 wt %, or in a range from about 20 wt % to about 25 wt %.

It should be noted that glacial acetic acid begins to freeze at temperatures below approximately 17° C. Accordingly, in some embodiments, the temperature of the etchant may be in a range from about 18° C. to about 90° C., for example in a range from about 18° C. to about 40° C., in a range from about 18° C. to about 35° C., in a range from about 18° C. to about 30° C., in a range from about 18° C. to about 25° C., or even in a range from about 18° C. to about 22° C. Etchant temperatures in the lower ranges, for example, in a range from about 18° C. to about 30° C., are favored, since this can reduce vapor pressure and produces fewer vapor-related defects on the glass.

In addition, the temperature of the glass substrate itself at the time the glass substrate is exposed to the etchant can affect etching results. Accordingly, the glass substrate when exposed to the etchant may be at a temperature in a range from about 20° C. to about 60° C., for example in a range from about 20° C. to about 50° C., or in a range from about 30° C. to about 40° C. The optimal temperature will depend on glass composition, environmental conditions and the desired texture (e.g., surface roughness). The etchant bath, if a bath is used, may in some instances be recirculated to prevent stratification and depletion of the etchant.

Etch times can extend from about 10 seconds to less than about 30 seconds, for example in a range from about 10 seconds to about 25 seconds, in a range from about 10 seconds to about 20 seconds, or in a range from about 10 seconds to about 15 seconds, although other etch times as may be needed to achieve the desired surface texture may also be used. Surface texture of the glass substrate after etching can vary with glass composition. Accordingly, etchant recipes optimized for one glass composition may require modification for other glass compositions. Such modification is typically accomplished through experimentation within the etchant constituent ranges disclosed herein.

In some embodiments one or more additives may be incorporated into the etchant. For example, a dye may be added to the etchant to add color and produce a visual aid for rinsing. In addition, as previously described, viscosity modifying components may be added to increase the viscosity of the etchant and enable slot, slide or curtain coating etchant on the glass substrate rather than by dipping, to provide the glass substrate with a uniform appearance. A high viscosity etchant may reduce the vapor pressure of the etchant and thereby reduce vapor-induced defects. Accordingly, the viscosity of the etchant can be adjusted to be compatible with the selected method of application, as needed. Suitable polymers, such as polycaprolactone, that are soluble in acetic acid may be used to modify the rheology of the etch solutions.

In a fourth step, the glass substrate is removed from the etchant and allowed to drain, then rinsed one or more times with a rinsing liquid. For example, the rinsing liquid can be deionized water. Alternatively, or in addition, the glass substrate can be rinsed in a solution in which the precipitant is dissolvable. For example, the glass substrate can be soaked in a 1 molar (M) solution of H₂SO₄ for up to 1 minute to remove crystalline residue on the surface after etching is completed. However, the H₂SO₄ can be replaced by other mineral acids such as HCl or HNO₃. A low pH value (or high temperature) can increase the solubility of the precipitated crystals. After the acid rinse, if applied, the glass substrate should be rinsed with water, such as deionized water, to remove the acid residue. In some embodiments, the rinse steps can employ agitation to prevent defects in the textured surface. Agitation of either the glass substrate or the rinse liquid sufficient to ensure uniform diffusion of fluoride-containing acid clinging to the glass substrate may be performed during rinsing. Small oscillations of approximately 300 oscillations per minute are sufficient, for example between about 250 and 350 oscillations per minute. The rinsing solution can be heated in one or more of the rinsing actions. In some embodiments, the rinsing liquid can include other fluids in which precipitant from the etching process is dissolvable.

In an optional fifth step of the process, any etchant-blocking film previously applied to the back side of the glass substrate, e.g., film 16, can be removed, such as by peeling.

In a sixth step of the process, glass substrate 10 can be dried using forced clean (filtered) air to prevent water spots, or spots from other rinsing solutions, from forming on the glass substrate.

The example process described above can be used to provide the specific textures described herein, and also to enable high uniformity of etched texture for each sample when combined with aspects of the following detailed description.

In a subsequent optional step, the glass substrate may be subject to an ion exchange (IOX) process after etching if desired and the glass substrate 10 is capable of being ion exchanged. For example, ion-exchangeable glasses suitable for use in embodiments described herein include without limitation alkali aluminosilicate glasses or alkali aluminoborosilicate glasses, though other glass compositions may be substituted. As used herein, being capable of ion exchange means a glass capable of exchanging cations located at or near the surface of the glass substrate 10 with cations of the same valence that are either larger or smaller in size.

The ion exchange process is carried out by immersion of the glass substrate 10 into a molten salt bath for a predetermined period of time, where ions within the glass substrate at or near the surface thereof are exchanged for larger metal ions, for example, from the salt bath. By way of example, the molten salt bath may include potassium nitrate (KNO₃), the temperature of the molten salt bath may be within a range from about 400° C. to about 500° C., and the predetermined period of time may be within a range from about 4 hours to 24 hours, for example in a range from about 4 hours to 10 hours. Incorporation of larger ions into glass substrate 10 strengthens surfaces of the glass substrate by creating a compressive stress in a near-surface region. A corresponding tensile stress is induced within a central region of the glass substrate 10 to balance the compressive stress.

By way of further example, sodium ions within glass substrate 18 may be replaced by potassium ions from the molten salt bath, though other alkali metal ions having a larger atomic radius, such as rubidium or cesium, may replace smaller alkali metal ions in the glass. According to particular embodiments, smaller alkali metal ions in glass substrate 10 may be replaced by Ag+ ions. Similarly, other alkali metal salts such as, but not limited to, sulfates, halides, and the like may be used in the ion exchange process. The replacement of smaller ions by larger ions at a temperature below that at which the glass network can relax produces a distribution of ions across the surface of the glass substrate 10 that results in a stress profile. The larger volume of the incoming ion produces a compressive stress (CS) on the surface and tension (central tension, or CT) in the center region of the glass substrate 10. The glass substrate after ion exchange can be subjected to a final water rinse if desired, followed by drying.

### EXAMPLES

Ternary etchant solutions were prepared by manually mixing glacial acetic acid, ammonium fluoride, and water. Ammonium fluoride crystals (Fischer Chemical CAS 12125-01-8, certified ACS) were weighed in a suitably sized container followed by the addition of deionized (DI) water (18.2 MOhm-cm), and lastly glacial acetic acid (Fischer Chemical CAS 64-19-7, certified ACS). All treatments were applied to approximately 10 cm×10 cm coupons of Corning® Lotus™ NXT glass, washed in a 4% Semiclean KG detergent bath (70° C. for 12 minutes followed by DI water rinse and air dry) and immersed in the etchant solution at room temperature for times of 10 seconds, 20 seconds, and 30 seconds. Table 1 shows specific etchant formulations in wt %.

TABLE 1

| Solution No. | CH₃COOH | NH₄F | H₂O |
|---|---|---|---|
| S1 | 56.27 | 10 | 33.73 |
| S2 | 60 | 10 | 30 |
| S3 | 50 | 20 | 30 |
| S4 | 55 | 25 | 20 |

The resulting average roughness found to be effective to reduce surface voltage (e.g. electrostatic charging), expressed as an average roughness (Rₐ) is typically in a range from about 0.4 nanometers (nm) to about 10 nm.

FIG. 2 is a graph depicting electrostatic charging reduction as a function of etch time for the four etching solutions S1, S2, S3 and S4. As indicated, the treatment methods described herein can result in a reduction of surface voltage exhibited by a glass substrate surface from about 30% to about 90% over the untreated substrate surface when tested via a Lift Test, for example in a range from about 40% to about 90%, in a range from about 50% to about 90%, in a range from about 60% to about 90%, in a range from about 70% to about 90%, or in a range from about 80% to about 90%, including all ranges and subranges therebetween. The Lift Test comprises a flat vacuum surface (e.g., vacuum plate) fitted with a 10 cm×10 cm stage plate, and insulating lift pins surrounding the stage plate, and an array of electrostatic field meters suspended above the glass plate surface. The measurement sequence begins with the sample to be tested placed on lift pins positioned in the vacuum plate, etched surface down. High-flow corona discharge-type ionizers are used to eliminate any residual charge in the sample. Vacuum is generated via a venturi method and the sample is lowered onto the vacuum plate using the lift pins, thereby creating contact between the glass plate and the vacuum surface under a constant and controlled pressure. This state is maintained for several seconds, after which the vacuum is released and the glass sample plate raised from the vacuum surface via the lift pins to a height of about 80 cm (about 10 mm below the field meter array). The glass surface voltage is monitored and recorded by the field meters for a period sufficiently long to obtain data for the maximum voltage generated from the vacuum process as well as its subsequent decay rate. This process is repeated six times for each glass sample plate for a total of three samples per etch condition. Control samples of non-etched, cleaned glass are measured in addition to the processed (etched) samples. The data is presented in terms of percent ESC improvement. This quantity represents the percent change (decrease or increase) in the maximum lift test voltage V (V@80 cm lift pin height) as obtained from etched samples relative to untreated, un-etched samples. For example, a 0% percent change would indicate the same voltage generation as the control sample; 100% would indicate virtual elimination of surface voltage generation; and −100% would indicate a two-fold increase in surface voltage generation over the control sample. The testing is performed in a Class 1000 cleanroom and 40% relative humidity (RH), with the apparatus itself contained within an anti-static acrylic housing equipped with dedicated high-efficiency particulate arresting (HEPA) air filtration.

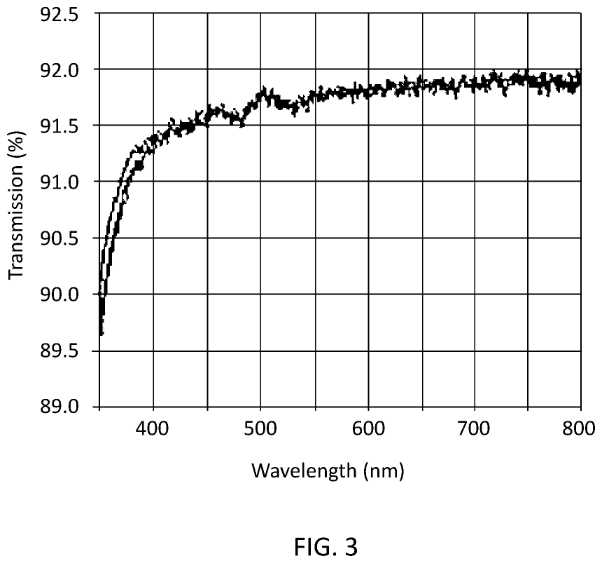

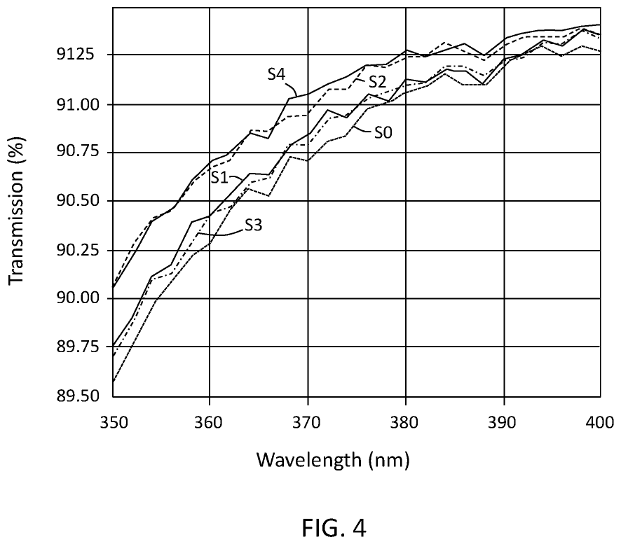

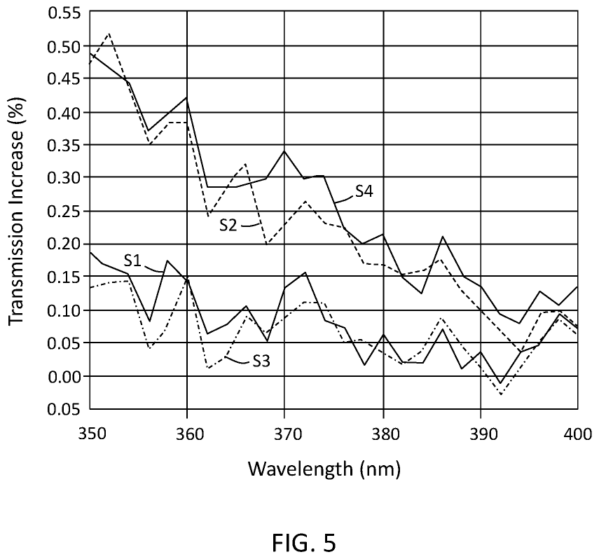

An additional advantage of the surface treatments disclosed herein is an unexpected anti-reflective effect in the near ultraviolet (UV) portion of the wavelength spectrum (e.g., in a wavelength range from about 350 nm to about 400 nm) relative to untreated glass. FIG. 3 is a graph showing optical transmission of four post-etch samples S1-S4 of Corning® Lotus™ NXT glass, and an otherwise identical un-etched sample S0, expressed as a percent as a function of wavelength in nanometers. The data show no significant deviation over substantially the entire wavelength range of 350 nm to 800 nm. Accordingly, the individual plot curves overlap and are indistinguishable from each other (and hence unlabelled). The exception is over the wavelength range of from about 350 nm to about 400 nm, where deviation in results occurred. A closer look at the wavelength band from about 350 nm to about 400 nm is provided in Table 2 and FIGS. 4 and 5.

Table 2 lists post-etch average total transmission across both full (400 nm-800 nm) and abbreviated (350 nm-400 nm) wavelength ranges for samples S1-S4. As indicated, S2 and S4 provide an about 0.25% increase or more in total transmission in the wavelength range from about 350 nm to about 400 nm, while maintaining a virtually identical average to the control glass over the range from about 400 nm to about 800 nm. For applications that require every possible bit of transmission in the near UV region, even a small increase in transmission may be valuable.

TABLE 2

| Wavelength | S1 | S2 | S3 | S4 | S0 |
|---|---|---|---|---|---|
| 400 nm-800 nm | 91.73 | 91.76 | 91.75 | 91.77 | 91.75 |
| 350 nm-400 nm | 90.83 | 90.98 | 90.81 | 91.00 | 90.75 |

FIGS. 4 and 5 graphically depict post-etch total transmission for samples etched with etchants S1-S4, with comparison to an untreated sample (S0) (FIG. 4), and transmission difference expressed as a transmission increase of the treated surface compared to the otherwise identical untreated surface of sample S0, over a wavelength range from about 350 nm to about 400 nm (FIG. 5).

Simultaneously, haze values for each of the samples was less than 1% when measured using a BYK Hazegard® instrument.

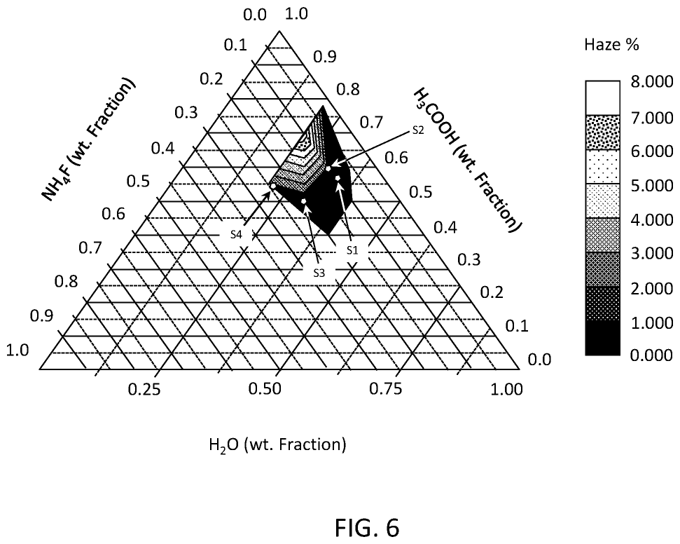

Indeed, FIG. 6 is a ternary plot showing a suitable etchant space (shown in black) and further indicating the location on the ternary plot for the four etchants S1-S4. The data show that each of the four sample etchants are capable of producing glass substrates with less than 1% haze. It is anticipated that the region shown in black, in its entirety, is suitable for producing glass substrates with less than 1% haze.

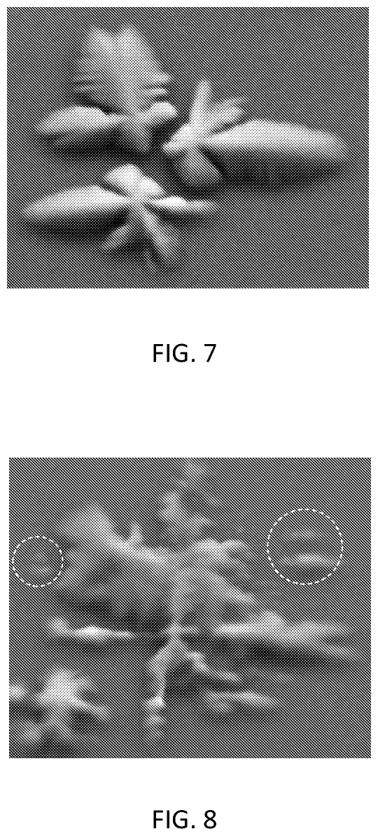

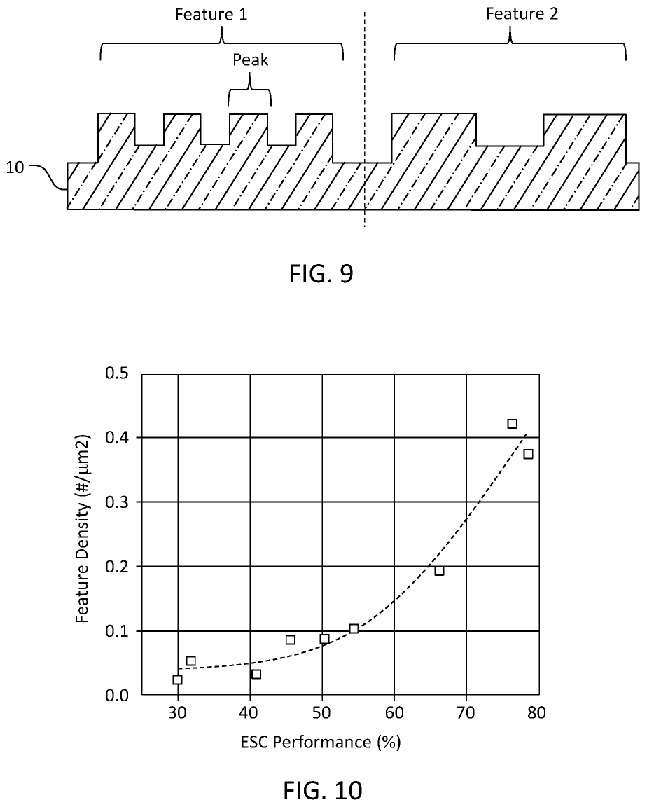

Experimental data, combined with electron microscopy, have shown that the surface topography of the subject glass substrate is particularly determinative of the ESC performance of the etched glass plate. See for example, FIGS. 7 and 8. FIG. 7 is an image obtained from electron microscopy illustrating raised texture “features” on a treated (post-etch) glass surface that, while exhibiting a general “branching” or fractal-like behavior, are nevertheless generally smooth in appearance. The raised features represent areas of the glass surface on which precipitate resided during the etching process. The raised texture features are shown after removal of the overlying precipitate. On the other hand, FIG. 8 depicts features on another glass sample comprising many more peaks (and valleys) than those illustrated in FIG. 7. It was determined during testing and sample characterization that more raised features per unit area yields better ESC performance (less electrostatic charging of the glass sample surface). However, a second-order effect was also observed: that peak density (peaks per unit surface area) had the opposite trend. Features and peaks are illustrated with a simple graphic in FIG. 9. FIG. 9 illustrates two raised features, feature 1 and feature 2, on a surface of glass substrate 10. Feature 1 exhibits four peaks, while feature 2 exhibits two peaks. Feature 1 and feature 2, while shown in cross section, are assumed to have approximately the same contact surface area (footprint). Thus, Feature 1 exhibits a greater peak density than feature 2 and the peaks are broader such that feature 2 exhibits a relatively smoother appearance than feature 1.

Returning then to FIG. 7, three distinct raised features are depicted that are generally smooth in appearance. However, FIG. 8, while essentially showing only two such distinct raised features (located at the center of the image and in the lower left corner), the central feature as an example exhibits more pronounced peaking (a greater per unit density of peaks) than shown in FIG. 7. As described herein, a single feature is defined by the general continuity of the feature. Thus, while FIG. 8 shows several small raised and separated regions to the right and left of the central feature (circled), these small raised areas are de minimis relative to the central feature.

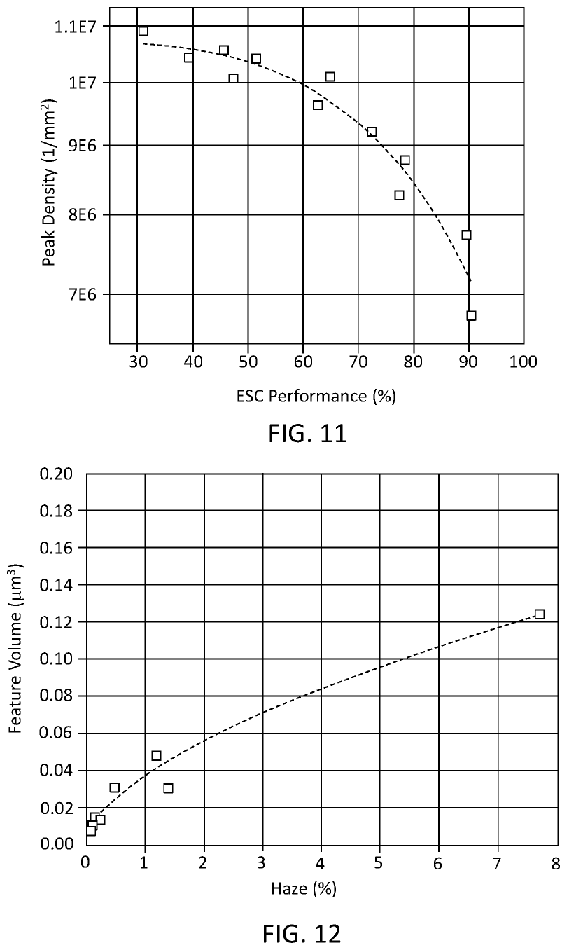

FIG. 10 is a plot of ESC performance as a function of feature density, showing that as feature density (expressed here as the number of features per square micrometer) increases, ESC performance increases (there is a reduction in electrostatic charging of the sample, indicted as a percent change when compared to an un-etched sample). On the other hand, FIG. 11 depicts ESC performance as a function of peak density (expressed as inverse area, l/mm²), illustrating that as peak density decreases, ESC performance increases (a reduction in electrostatic charging).

The foregoing does not, however, readily translate into haze performance. Optical haze has been shown to be more directly affected by feature size (e.g., feature volume) than by feature or peak density. Raised feature volume is calculated using average feature area and height via binary image processing. For example, individual features can be approximated by a cone of an appropriate height and base radius, and a volume calculated therefrom. FIG. 12 is another plot showing percent haze as a function of feature volume (expressed as cubic micrometers). The plot of FIG. 12 shows that as feature volume increases, so does haze. To wit, smaller volume features can yield reduced haze. Accordingly, taking the foregoing data into account, many small, smooth features can result in reduced electrostatic charging (improved ESC performance), and reduced haze. Experimental data has shown that, in some embodiments, feature volume should be maintained within a range from about 0.014 μm³ to about 0.25 μm³. In some embodiments, feature density should be maintained in a range from about 0.2/μm² to about 1/μm². In some embodiments, the areal feature coverage of the glass surface (calculated as the total two-dimensional area of the major glass surface defined by features divided by the total area of the major surface) should be in a range from about 4% to about 35%. If feature coverage exceeds about 35%, haze can increase beyond acceptable levels.

It will be apparent to those skilled in the art that various modifications and variations can be made to the disclosed embodiments without departing from the spirit and scope of the disclosure. Thus, it is intended that the present disclosure cover the modifications and variations of these embodiments provided they come within the scope of the appended claims and their equivalents.

1. A glass substrate comprising a chemically treated major surface, the glass substrate comprising a haze value equal to or less than about 1% and, when compared to an untreated otherwise identical glass substrate, further comprises an improvement in ESC performance of greater than 70% when subjected to a Lift Test performed on the chemically treated major surface.

2. The glass substrate according to claim 1, wherein the glass substrate further comprises an improvement in transmittance of greater than 0.25% over a wavelength range from 350 nm to 400 nm when compared to the untreated otherwise identical glass substrate.

3. The glass substrate according to claim 1, wherein the glass substrate is a chemically strengthened glass substrate.

4. The glass substrate according to claim 1, wherein the glass substrate is a laminated glass substrate comprising a first glass layer with a first coefficient of thermal expansion, and a second glass layer fused to the first glass layer and comprising a second coefficient of thermal expansion different from the first coefficient of thermal expansion.

5. The glass substrate according to claim 1, wherein the chemically treated major surface comprises a plurality of raised features, and an average feature density of the raised features is in a range from about 0.2 features/μm² to about 1 features/μm².

6. The glass substrate according to claim 5, wherein an average feature volume of the raised features is in a range from about 0.014 μm³ to about 0.25 μm³.

7. The glass substrate according to claim 5, wherein a total surface area of the raised features relative to the total surface area of the chemically treated major surface is in a range from about 4% to about 35%.

8. The glass substrate according to claim 1, wherein an average surface roughness Ra of the chemically treated major surface is in a range from about 0.4 nanometers to about 10 nanometers.

9. A method of forming a textured glass substrate comprising:
treating a major surface of a glass substrate with an etchant comprising acetic acid in an amount from about 50 wt % to about 60 wt %, ammonium fluoride in an amount from about 10 wt % to about 25 wt %, and water in an amount from about 20 wt % to about 35 wt %.

10. The method according to claim 9, wherein during the treating the major surface of the glass substrate is exposed to the etchant for a time less than about 30 seconds.

11. The method according to claim 10, wherein during the treating the glass substrate is at a temperature in a range from about 18° C. to about 60° C.

12. The method according to claim 9, wherein an average surface roughness Ra of the major surface after the treating is in a range from about 0.4 nanometers to about 10 nanometers.

13. The method according to claim 9, wherein after the treating, the glass substrate exhibits a total haze value less than 1% and, when compared to an untreated but otherwise identical glass substrate, exhibits an increase in ESC performance greater than 70% when subjected to a Lift Test performed on the chemically treated major surface.
